(19) United States
(12) Patent Application Publication
(10) Pub. No.: US 2024/0188537 A1
(43) Pub. Date: Jun. 13, 2024

(54) Biothane Animal Grooming Safety Tether

(71) Applicant: Pro-Mohs Pet Products, Loretto, MN (US)

(72) Inventor: Michael Thomas Ward, Loretto, MN (US)

(21) Appl. No.: 18/523,097

(22) Filed: Nov. 29, 2023

Related U.S. Application Data
(60) Provisional application No. 63/386,342, filed on Dec. 7, 2022.

(51) Int. Cl. A01K 13/00; A01K 27/00

(52) U.S. Cl. CPC A01K 13/00; A01K 27/00

(57) ABSTRACT

A device, Biothane Animal Grooming Safety Tether, is provided. The device comprises a first band, a second band, and a fastener which can be a snap hook. The first band includes a buckle and the first band and the second band may include box stitches.

### FIELD OF THE INVENTION

The present invention relates to a pet restraint device. More specifically, the present invention relates to restraint loops for use by pet groomers and other pet or animal handlers.

### BACKGROUND OF THE INVENTION

A pet restraint device for use by pet groomers and other animal handlers is in demand.

A dog restraint loop is a device designed to keep a dog or other pet on the grooming table or in the tub while being bathed. A dog restraint loop helps the restrained dog feel more secure, which typically makes the animal easier to handle. In addition, restraint is necessary when pets are groomed, bathed, or dried after bathing, etc. However, many of the currently available pet-restraining devices on the market include uncomfortable designs for pets, and some may even injure pets.

Generally, a dog restraint loop includes simple components. It is connected to an eye bolt hanging from the upper end of an L-shaped grooming arm by a swivel snap that engages the eye bolt. It is typically designed to be placed over the animal's head and then to rest around the neck. Once the animal's movements are restricted by the loop, the groomer then cuts, combs, and performs all other grooming procedures required by specific breeds.

However, using the loop alone does not fully restrict the animal's movement. Consequently, while attached to the loop, the pet may be able to move in a circle, turn to bite the handler, or even fall off the table. All of these actions are undesirable and dangerous to both the pet and the handler. Thus, there is a need to develop a device that solves the problem.

The present invention is intended to address problems associated with and/or otherwise improve on conventional devices through an innovative pet restraint device designed to provide a convenient and effective means of restraining animals while incorporating other problem-solving features.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

A device, Biothane Animal Grooming Safety Tether, is provided. The device comprises a first band, a second band, and a fastener which can be a snap hook. The first band includes a buckle and the first band and the second band may include box stitches.

In some embodiments, the device of the present invention comprises a first band attached to a grooming arm, a second band having a ring band attached to the first band by the ring band, the second band is attached to a grooming loop having a size adjustment ring, configured to be wrapped around an animal's neck, wherein the grooming loop is attached to the grooming arm, and a fastener attached to the second band.

### BRIEF DESCRIPTION OF THE DRAWINGS

FIG. 1 is an illustration of one embodiment of the present invention.

FIG. 2 is an illustration of one embodiment of the present invention showing how a camlock can be utilized.

FIG. 3 is an illustration of one embodiment of the present invention installed on a grooming arm.

FIG. 4 is an illustration of one embodiment of the present invention installed on a grooming arm and a dog.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.” The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

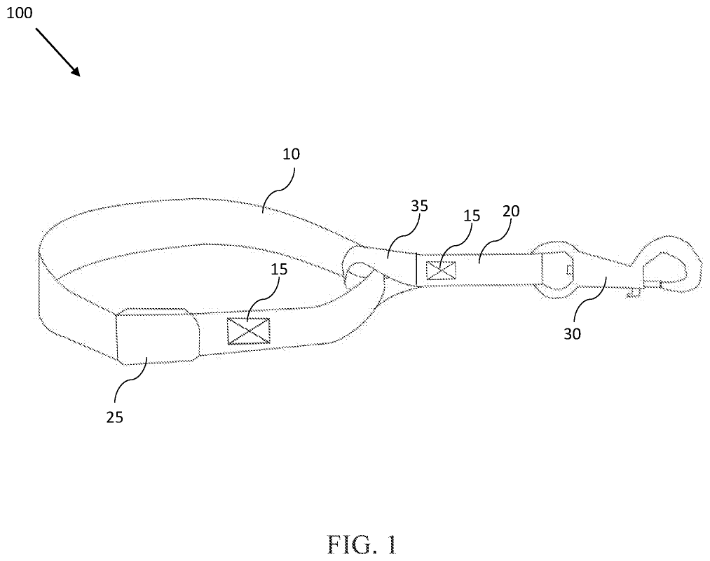

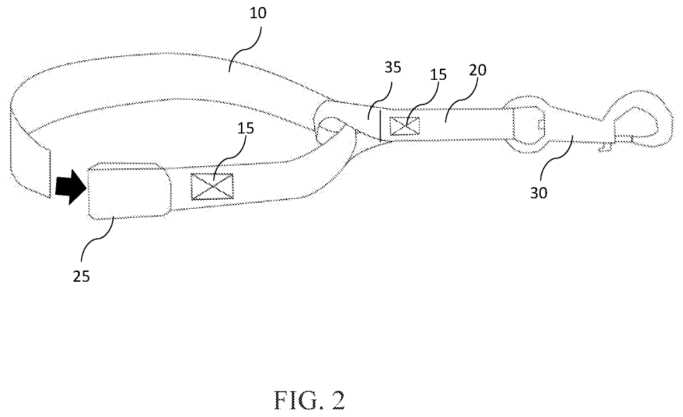

The present invention, as shown in FIGS. 1-4, provides a device 100 (a Biothane Animal Grooming Safety Tether) comprising a plurality of bands 10, 20 (strips), a camlock buckle 25, and a chrome snap 30.

In preferred embodiment, the plurality of bands 10, 20 (strips) may include a first band 10 and a second band 20 which is attached to the first band 10. The device may further include a fastener 30 attached to the second band 20. The first band 10 may include a buckle (camlock buckle) 25.

In one embodiment, the second band 20 may include a ring band 35 so that the first band 10 can be attached to the second band 20 via the ring band 35 (e.g., the first band 10 can be put through the ring band 35 attached to the second band 20).

The first band 10 and/or the second band 20 may include one or more box stitches 15.

In some embodiments, the fastener 30 can be a snap hook (chrome snap).

In one embodiment, the bands 10, 20 (strips) can include a first strip that is a 8″ strip of ¾″ Biothane strip made from a polyester webbing with PVC coating, which provides a waterproof, durable and easy to clean product.

In one embodiment, the camlock buckle can be attached to the first band 10 (strip) and made from a metal material or plastic such as Pebax® (polyether block amide), Hytrel (polyester elastomer), nylon 12, nylon 11, nylon 6, nylon 6,6, polyethylene, polyurethane or other suitable polymer.

In one embodiment, the chrome snap 30 (snap hook) can be a 3″ chrome snap attached to a second band 20 (biothane strip) to create 2″ long strap that is also attached to the first band 10 (strip).

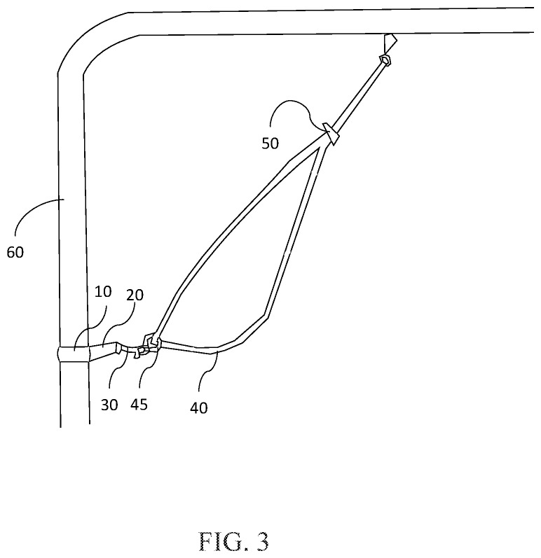

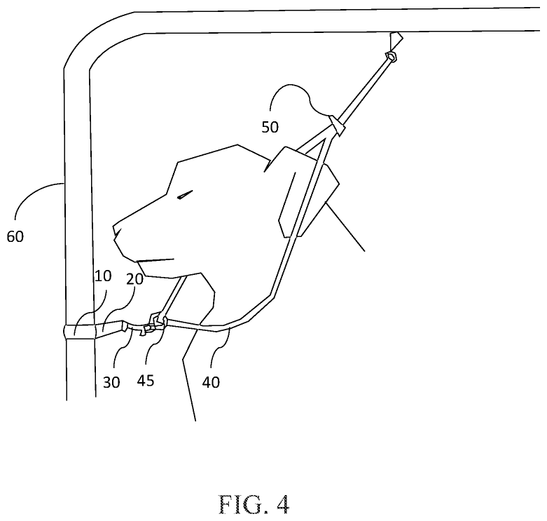

As shown in FIGS. 3-4, the present invention (The Biothane Animal Grooming Safety Tether) may further include a grooming arm 60 and the first band 10 can be is designed to wrap around a lower portion of a grooming arm 60 which is essentially an inverted L-shaped post. The grooming arm 60 can be configured to be mounted to a grooming table via a grooming arm clamp or any other similar fastening mechanisms. In some embodiments, the first band 10 can be adjusted up or down, in order to accommodate the size of the dog or pet. The present invention is designed to fit most grooming arms 60.

The present invention is designed to be adjusted up or down along the arm 60 to accommodate the size of the animal. The present invention is then tightened with a metal camlock buckle 25 to secure the position.

In some embodiments, the present invention may further include a grooming loop 40 having a ring 45. The snap end 30 can be then secured to the ring 45 on the grooming loop 40 that is around the animal's neck. This restricts the animal's ability to turn its head or back up. This is a durable and economical solution for groomers. In some embodiments, the grooming loop 40 may include an adjustment ring 50 configured to adjust the size of the grooming loop 40.

In one embodiment, the second band 20 can be attached to a grooming loop 40 having a size adjustment ring 50, wherein the grooming loop 40 is configured to be wrapped around an animal's neck, and the grooming loop 40 is attached to the grooming arm 60. In such embodiments, the first band 10 can be attached to the grooming arm 60, the first band 10 is attached to the second band 20 which is attached to the grooming loop 40 via fastener and the grooming loop 40 can be attached to the grooming arm 60.

Although the invention has been explained in relation to its preferred embodiment, it is to be understood that many other possible modifications and variations can be made without departing from the spirit and scope of the invention.

What is claimed is:

1. A device comprising:
a first band,
a second band attached to the first band, and
a fastener attached to the second band.

2. The device as claimed in claim 1, wherein the first band includes a buckle.

3. The device as claimed in claim 2, wherein the first band includes a box stitch.

4. The device as claimed in claim 3, wherein the second band includes a box stitch.

5. The device as claimed in claim 4, wherein the fastener is a snap hook.

6. The device as claimed in claim 5, wherein the first band is made of a rubber coated nylon material.

7. The device as claimed in claim 1, wherein the second band is made of a rubber coated nylon material.

8. A device comprising:
a first band attached to a grooming arm,
a second band having a ring band attached to the first band by the ring band, and
a fastener attached to the second band.

9. The device as claimed in claim 8, wherein the first band includes a buckle.

10. The device as claimed in claim 9, wherein the first band includes a box stitch.

11. The device as claimed in claim 10, wherein the second band includes a box stitch.

12. The device as claimed in claim 11, wherein the fastener is a snap hook.

13. The device as claimed in claim 12, wherein the first band is made of a rubber coated nylon material.

14. The device as claimed in claim 8, wherein the second band is made of a rubber coated nylon material.

15. A device comprising:
a first band attached to a grooming arm,
a second band having a ring band attached to the first band by the ring band, the second band is attached to a grooming loop having a size adjustment ring, configured to be wrapped around an animal's neck,
wherein the grooming loop is attached to the grooming arm, and
a fastener attached to the second band.

16. The device as claimed in claim 15, wherein the first band includes a buckle.

17. The device as claimed in claim 16, wherein the first band includes a box stitch.

18. The device as claimed in claim 17, wherein the second band includes a box stitch.

19. The device as claimed in claim 18, wherein the fastener is a snap hook.

20. The device as claimed in claim 15, wherein the first band is made of a rubber coated nylon material.
